(19) United States
(12) Patent Application Publication
(10) Pub. No.: US 2024/0353732 A1
(43) Pub. Date: Oct. 24, 2024

(54) DEVICE FOR GENERATING PULSES IN THE MID-INFRARED AND ASSOCIATED GENERATING METHOD

(71) Applicants: AMPLITUDE, PESSAC (FR); INSTITUT D'OPTIQUE THÉORIQUE ET APPLIQUÉE, PALAISEAU (FR); CENTRE NATIONAL DE LA RECHERCHE SCIENTIFIQUE, PARIS (FR)

(72) Inventors: Yoann ZAOUTER, BOULOGNE-BILLANCOURT (FR); Florent GUICHARD, BORDEAUX (FR); Michele NATILE, PALAISEAU (FR); Quentin BOURNET, PARIS (FR); Marc HANNA, LIMOURS (FR)

(21) Appl. No.: 18/578,567

(22) PCT Filed: Jul. 12, 2022
(86) PCT No.: PCT/EP2022/069507

§ 371 Date: Jan. 11, 2024

(30) Foreign Application Priority Data
Jul. 15, 2021 (FR) 2107663

(51) Int. Cl. G02F 1/35; G02F 1/39

(52) U.S. Cl. CPC G02F 1/3501; G02F 1/3534; G02F 1/39

(57) ABSTRACT

This relates to a device for generating at least one pulse in the mid-infrared, including an optical source that emits at least one source pulse having a first spectral component of wavelength λ₁ and a second spectral component of wavelength 22, a non-linear crystal configured to generate the at least one pulse at a wavelength λMIR in the mid-infrared via a difference-frequency-generation process, and a first optical parametric amplifier. According to the invention, the generating device includes at least one retarder placed between the non-linear crystal and the first optical parametric amplifier, the retarder generating an optical delay suitable for synchronizing in the first optical parametric amplifier the at least one pulse of wavelength λMIR with pump radiation at the first wavelength 2 or at the second wavelength 22.

### TECHNICAL FIELD OF THE INVENTION

The present invention relates in a general manner to the generation of radiation in the mid-infrared.

It relates more particularly to a device for generating pulses in the mid-infrared and an associated generating method.

The invention finds a particularly advantageous application in the field of the molecular detection for medical, environmental, or scientific purposes, but also of time-resolved spectroscopy and strong field physics.

### STATE OF THE ART

The mid-infrared (MIR, between 2.5 and 50 microns) and the multi-Terahertz range (between 50 microns and 300 microns) are ranges of the electromagnetic spectrum of strong scientific and industrial interest. We distinguish in particular these ranges of the electromagnetic spectrum from that of the near infrared (NIR, between 0.7 and 2.5 microns).

Currently, in the absence of laser systems emitting short pulses directly at the MIR wavelengths of interest, most of the techniques of generation of MIR radiation are based on a nonlinear optical process called difference frequency generation operated in different ways. We distinguish basically a method said of interpulse difference frequency and a method called intra-pulse difference frequency (iDFG).

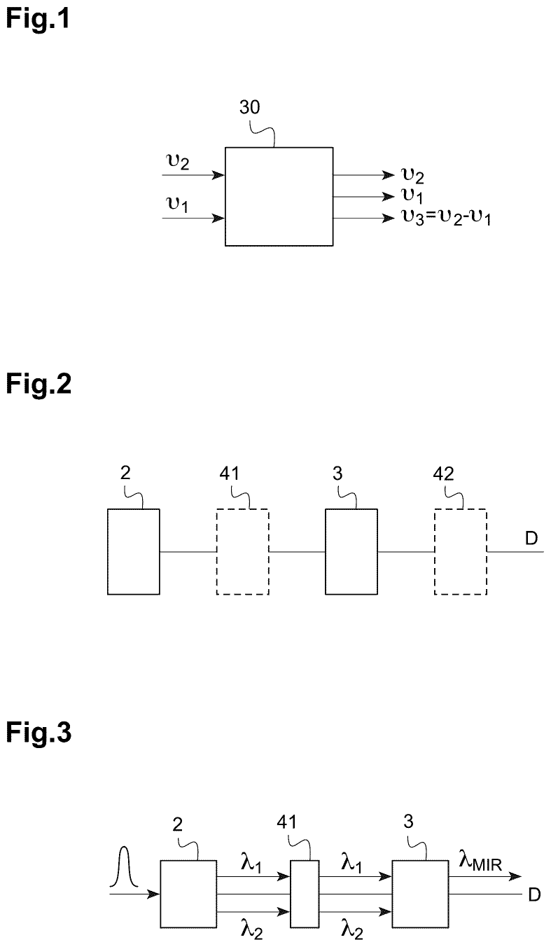

The difference frequency generation process is a nonlinear process by which two incoming waves having respective central optical frequencies v₂ and v₁ interact with one another in a nonlinear optical medium such as a nonlinear optical crystal 30 (hereinafter referred to as nonlinear crystal), and generate a third wave having an optical frequency v₃ equal to the difference between the frequencies of the two incoming waves. This process is shown schematically in FIG. 1.

With the method referred to as inter-pulse difference frequency, the frequency process is implemented by using two distinct source pulses, originating or not from the same laser source, emitted at different wavelengths. The wavelength λ of an electromagnetic radiation is linked to its optical frequency v by the following relationship: v=c/λ, where c represents the speed of light in a vacuum. The wavelengths of the two distinct source pulses are chosen so that the difference in optical frequency between their respective optical frequencies is equal to an optical frequency whose wavelength corresponds to the desired MIR radiation.

With the so-called intra-pulse difference frequency method, a single short source pulse is used. Such a pulse of chosen duration can have a spectrum allowing to access at a desired optical frequency in the MIR. In this case, it is possible to generate a difference frequency between two distinct wavelengths of the spectrum of the single pulse, and thus an ultrashort pulse in the MIR at the desired optical frequency.

The two methods described above have in particular the disadvantage of either having a low conversion efficiency from the source pulse(s) to the MIR pulse, or of requiring production devices that are complex in structure and use.

### PRESENTATION OF THE INVENTION

In this context, the present invention provides a device for generating at least one pulse in the mid-infrared, comprising:
an optical source configured to emit at least one source pulse, the at least one source pulse having a first spectral component of wavelength λ₁ and a second spectral component of wavelength λ₂ located in a spectral range below the mid-infrared,
a nonlinear crystal configured to generate said at least one pulse with a wavelength λMIR in the mid-infrared from the at least one source pulse by a process of difference frequency generation between the first spectral component of wavelength λ₁ and the second spectral component of wavelength λ₂,
a first optical parametric amplifier, wherein:
the generation device comprises at least one retardation plate presenting an optical delay configured for two useful wavelengths, the two useful wavelengths being the wavelength λMIR in the mid-infrared and one among the first wavelength λ₁ and the second wavelength λ₂.
the generation device is a device aligned along an alignment optical axis, the retardation plate is placed between the nonlinear crystal and the first optical parametric amplifier,
the retardation plate is configured to receive said at least one pulse at the wavelength λMIR in mid-infrared originating from the nonlinear crystal and to transmit it towards the first optical parametric amplifier,
the retardation plate is configured to receive a pump radiation emerging from the nonlinear crystal at the first wavelength λ₁ or at the second wavelength λ₂,
   and for transmitting the pump radiation towards the first optical parametric amplifier,
the optical delay of the retardation plate is adapted to synchronize in the first optical parametric amplifier said at least one pulse at the wavelength λMIR in the mid-infrared with said pump radiation at the first wavelength λ₁ or at the second wavelength λ₂.

Thus, the invention advantageously makes it possible to increase the yield of a device for generating pulses in the mid-infrared via an optical parametric amplification process by using at least one plate introducing an optical delay. Also, the configuration <<All aligned>> of the device according to the invention facilitates its use and the alignment.

Other advantageous and non-limiting characteristics of the generation device compliant with the invention, taken individually or according to all technically possible combinations, are the following ones:
the retardation plate is a birefringent plate;
the material of the birefringent retardation plate and its cut are chosen to introduce a group velocity difference between said at least one pulse at the wavelength λMIR and said pump radiation at the first wavelength λ₁ or at the second wavelength λ₂, said group velocity difference being equal to the opposite of a group velocity difference, at the output of the nonlinear crystal, between said pump radiation and said at least one pulse at the wavelength λMIR;
the generation device further comprises one or more additional optical parametric amplifiers positioned in cascade and downstream of the first optical parametric amplifier and including another retardation plate upstream of each additional optical parametric amplifier; that allows to further improve the efficiency of the pulse generation process at the wavelength λMIR;
the generation device further comprises a dual plate;
the dual plate has an optical delay configured for two useful wavelengths, the two useful wavelengths being the first wavelength λ₁ and the second wavelength λ₂;
the dual plate is placed between the optical source and the nonlinear crystal;
the dual plate is configured to receive said at least one source pulse and to transmit it towards the nonlinear crystal;
the optical delay of the dual plate configured for the first wavelength λ₁ is equal to (N₁+1/2)×λ₁ and the optical delay of the dual plate configured for the second wavelength λ₂ is equal to N₂×λ₂, with λ₁ and λ₂ being two positive integers;
the dual plate has a fixed thickness;
the dual plate consists of a pair of straight prisms capable of moving in translation one in relation to the other, so that the thickness of the dual plate is variable; that allows you to adjust the wavelength λMIR as well as the spectral width of the pulse at the wavelength λMIR . . .
the dual plate is a birefringent plate;
the first spectral component of wavelength λ₁ and the second spectral component of wavelength λ₂ are spatially superimposed;
the first spectral component of wavelength λ₁ and the second spectral component of wavelength λ₂ are spatially separated and spectrally disjoint.

The invention is also related to a method of generation of at least one pulse in mid-infrared λ_{MIR} implemented by a generation device according to the invention, comprising the following steps:
emission by an optical source of at least one source pulse, the at least one source pulse having a first spectral component with the wavelength λ₁ and a second spectral component with the wavelength λ₂ located in the near infrared,
reception of the at least one source pulse by a nonlinear crystal,
generation by said nonlinear crystal of said at least one pulse at a wavelength λMIR from the at least one source pulse by a process of difference frequency generation between the first spectral component of wavelength λ₁ and the second spectral component of wavelength λ₂, rotation of the retardation plate in its plane, and optionally, rotations of the retardation plate in directions perpendicular to the alignment optical axis of the generation device.

Of course, the different characteristics, variants and embodiments of the invention can be associated with one another according to various combinations as long as they are not incompatible or exclusive of each other.

### DETAILED DESCRIPTION OF THE INVENTION

The description which follows with reference to the appended drawings, given as non restrictive examples, will well explain in what the invention consists of and how it can be achieved.

On the enclosed drawings:

FIG. 1 schematically illustrates the principle of the difference frequency generation process;

FIG. 2 is a schematic view of the device for generating at least one pulse in the mid-infrared according to the invention;

FIG. 3 is a schematic view of an example of the device for generating at least one pulse in the mid-infrared according to the present disclosure;

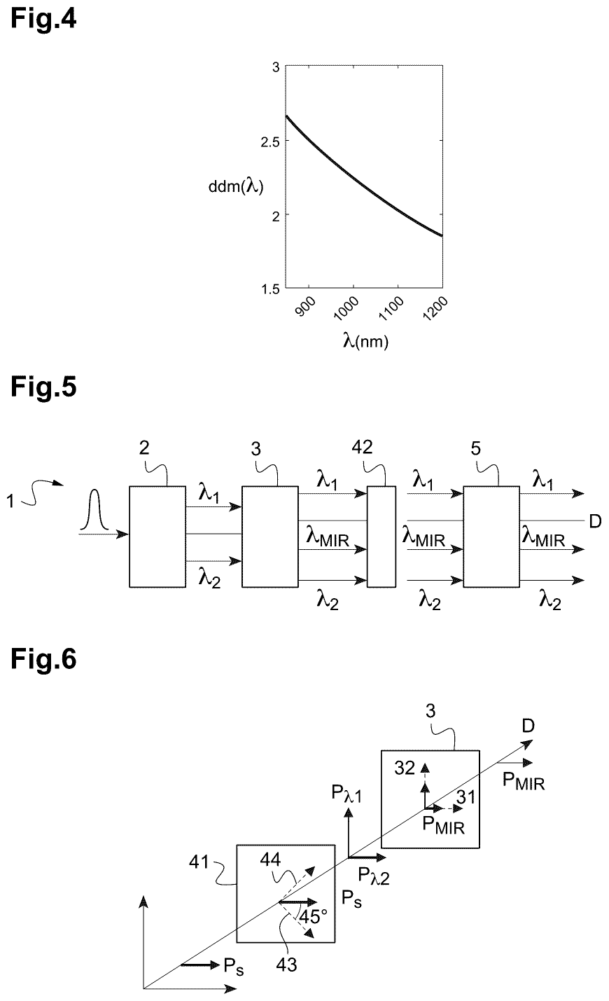

FIG. 4 represents an example of the dependence on wavelength of the optical delay introduced by a dual plate according to the present disclosure;

FIG. 5 is a schematic view of one embodiment of the device for generating at least one pulse in the mid-infrared according to the invention;

FIG. 6 schematically represents the principle of adjustment of the device for generating at least one pulse in the mid-infrared in the example of FIG. 3;

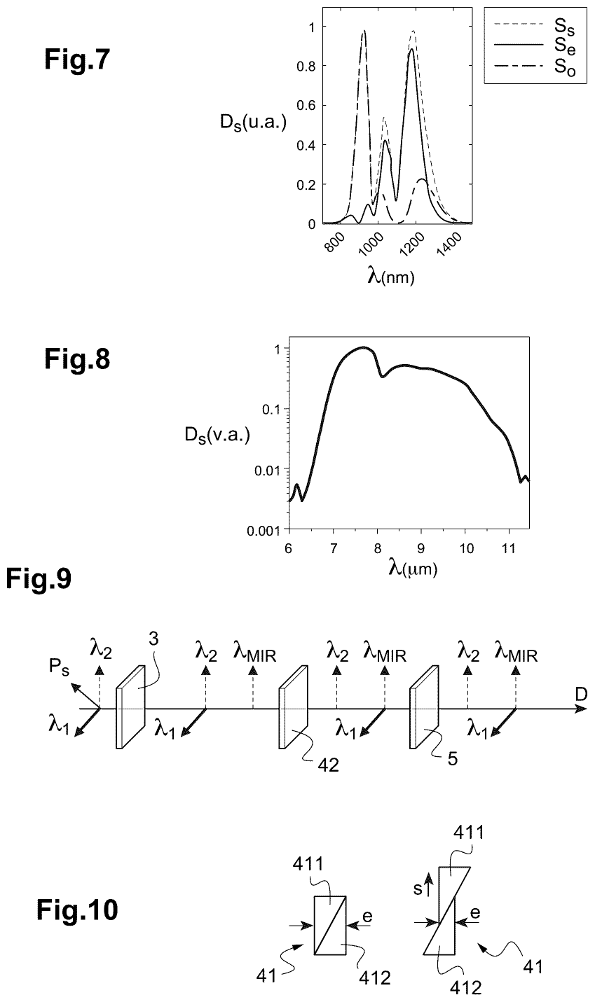

FIG. 7 represents the projections of the spectral components of the spectral density of the source of the generation device of at least one pulse in the mid-infrared along the own axes of the nonlinear crystal of the device for generating at least one pulse in the mid-infrared;

FIG. 8 is an example of a spectral density curve of a pulse in the mid-infrared generated by the generation device according to this disclosure;

FIG. 9 schematically represents the principle of an amplification of a pulse in the mid-infrared in the embodiment of FIG. 5;

FIG. 10 represents a variant of the dual plate according to the invention;

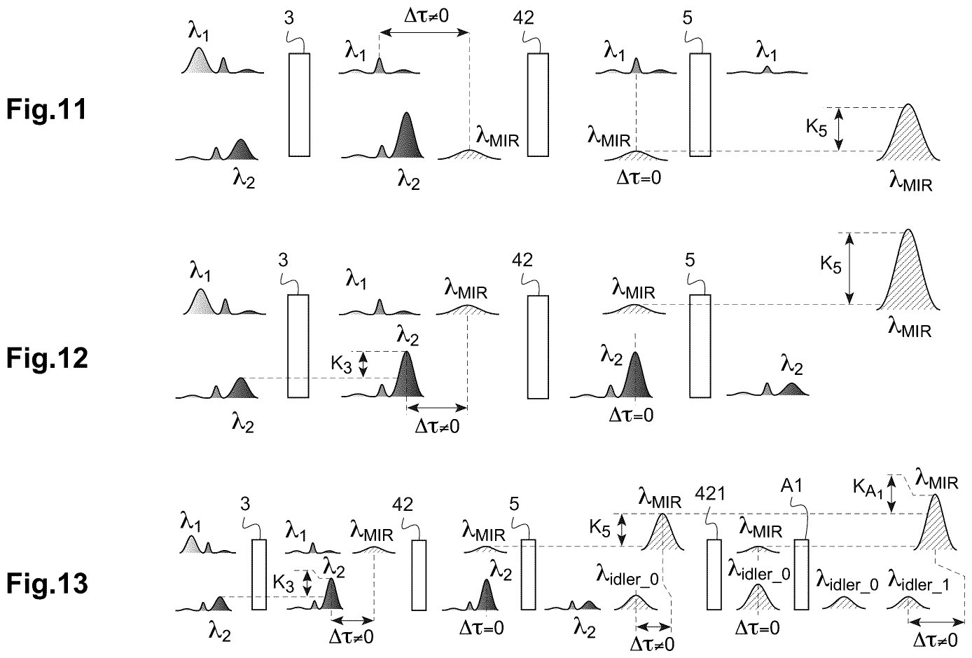

FIG. 11 illustrates a second variant comprising one or more optical parametric amplifiers in cascade and a complementary retardation plate upstream of each additional optical parametric amplifier;

FIG. 12 illustrates a third variant comprising one or more optical parametric amplifiers in cascade and a complementary retardation plate upstream of each additional optical parametric amplifier;

FIG. 13 illustrates a fourth variant comprising one or more optical parametric amplifiers in cascade and a complementary retardation plate upstream of each additional optical parametric amplifier.

### Device

FIG. 2 schematically illustrates the device for generating at least one mid-infrared pulse 1 according to the invention. The device 1 for generating at least one pulse in the mid-infrared according to the invention comprises an optical source 2, a nonlinear optical crystal 3, and a retardation plate 42. In the following, the nonlinear optical crystal 3 will be designated by “nonlinear crystal 3”. The optical source 2, the nonlinear crystal 3, and the plate 42 are aligned along an alignment optical axis D. The optical source 2 is placed upstream of the alignment axis D. The nonlinear crystal 3 is placed downstream of the optical source 2 and the retardation plate 42 is placed downstream of the nonlinear crystal 3.

The optical source emits at least one source pulse of wavelength between 0.4 microns and 2.5 microns, preferably between 0.7 microns and 2.5 microns, comprising a first spectral component of wavelength λ₁ and a second spectral component of wavelength λ₂. For example, the source can be a fiber amplifier doped with Ytterbium delivering source pulses with a central wavelength of 1030 nm, a duration of less than 13 fs, an energy of 160 microjoules and with a repetition frequency of 250 kHz, which are the specific characteristics of the Tangerine product coupled with a Compress-50 temporal compression module from the company Amplitude. In this example, the wavelength λ₁ is equal to 900 nm and the wavelength λ₂ is equal to 1120 nm.

In order to generate a spectral component As in the near MIR, by spectrally distancing the spectral components λ₁ and λ₂, the spectrum of the optical source 2 can be broadened by performing temporal compression of the source pulses.

For example, the fiber amplifier doped with Ytterbium previously evoked can be coupled to a two-stage nonlinear compression device of pulses. The source pulses are sent to a first nonlinear compression stage comprising a capillary tube with a length of 1 m and filled with Xenon at a pressure of 2.5 bar. At the exit of the capillary tube, the pulse beam is for example collimated and sent towards a pair of dispersives mirrors introducing a group delay dispersion of −1600 fs² The group delay is defined by the derivative of the spectral phase, that is to say the phase of the electric field in the frequency domain with respect to the angular frequency. The dispersion of the group delay is defined by the derivative of the group delay with respect to the angular frequency. Then, each one of the intermediate pulses emerging from the dispersive mirrors has a duration of 30 fs.

Optionally, the intermediate pulses then are sent towards a second nonlinear compression stage constituted for example of a plurality of silica plates being 1 mm thick and oriented according to the Brewster angle allowing multi-plate compression (MPC). The beam of pulses coming from the second stage and collimated and sent to a pair of dispersive mirrors introduce a group delay dispersion of −300 fs². Additional items such as plates of fluoride calcium can be added to the second stage. At the output of such a nonlinear pulse compression device having two stages, the source pulses coming from the fiber amplifier doped with Ytterbium have a duration of 12.9 fs.

The nonlinear crystal 3 is configured for generating at least one pulse of wavelength λMIR in the mid-infrared from said at least one source pulse by a process of difference frequency generation between the first spectral component of wavelength λ₁ and the second spectral component of wavelength λ₂.

The difference frequency generation is a nonlinear optical process of the mixture with three waves type. Two waves having different central wavelengths (or in an equivalent manner, optical frequencies) interact in a nonlinear medium to produce a wave whose central optical frequency is equal to the difference between the optical frequencies of the two initial signals.

As with any nonlinear optical process, a phase matching condition must be met. The phase matching condition is a relationship between the number of waves of the monochromatic waves being concerned by the nonlinear optical process. In the case of the difference frequency, the phase matching condition is a relationship between the number of waves of both waves λ₁ and λ₂ interacting in the nonlinear medium and the number of waves of the wave As obtained by difference frequency.

According to one embodiment, the nonlinear crystal 3 is a birefringent crystal in order to satisfy the phase matching condition for the difference frequency generation. By birefringent crystal is meant a crystal whose refractive index depends on the wavelength and the polarization. Advantageously, the nonlinear crystal 3 can be a langasite crystal (LiGaS₂ or LGS). Other examples of birefringent crystals that can be used are, for information only, crystals of BGS (BaGa₄S₇), GaSe (gallium selenide), AGGS (AgGeGaS₄), LiS (Li₂Ga₂GeS₆), LGN (La₃Ga_{5.5}Nb_{0.5}O₁₄).

The most frequently used configuration for the difference frequency generation with a birefringent crystal is that where the phase matching, that is to say where the two interacting waves have linear polarizations which are orthogonal and transverse to the propagation directions of the two waves, more precisely, along the own axes of the nonlinear crystal 3.

By the process of difference frequency generation, the nonlinear crystal 3 generates pulses having a lower optical frequency than those of the first spectral component and the second spectral component, that is to say a wavelength λMIR higher than the wavelengths λ₁ and λ₂. The wavelength λMIR thus depends on the wavelengths λ₁ and λ₂ according to the formula well-known of the person skilled in the art.

The retardation plate 42 has an optical delay configured for two useful wavelengths. The two useful wavelengths are the wave length λMIR in the mid-infrared and one of the first wavelength λ₁ and the second wavelength λ₂.

It is considered that the first spectral component of wavelength λ₁ and a second spectral component of wavelength λ₂ are contained in a same source pulse emitted by the optical source 2 and that this same source pulse has a linear polarization. Thus, an intra-pulse difference frequency process is implemented.

Advantageously, the nonlinear crystal is a birefringent crystal, arranged so that its two own axes, hereinafter called slow axis 31 and fast axis 32, are perpendicular to the alignment optical axis D of the device. By birefringent, a material is characterized whose index depends on the polarization of a light wave propagating in the material. By own axes of the birefringent crystal, the two polarization axes are meant for which one wave polarized parallel to one or the other of the two axes retains its polarization when crossing the birefringent crystal.

According to the current disclosure, a dual plate 41 can be placed transversely on the alignment optical axis of the generation device 1 between the optical source 2 and the nonlinear crystal 3 as illustrated in FIG. 3.

The dual plate 41 is here manufactured from one or a set of several birefringent materials, transparent at wavelengths λ₁ and λ₂, and has a predetermined thickness, so that it introduces an optical delay D1 configured for the first spectral component as equal to (N₁+1/2)×λ₁ and an optical delay D2 configured for the second spectral component as equal to N₂x λ₂, where N1 And N2 are two positive integers. Examples of birefringent materials for the dual plate 41 are calcite, quartz, yttrium vanadate, or gadolinium again. Typically, the dual plate 41 is a multi-order plate, that is to say that the integers N1 and N2 are greater than or equal to 1. The dual plate 41 has two own axes 43, a slow axis, and 44, a fast axis, in a plane transverse to the alignment optical axis D of the generation device 1.

FIG. 4 illustrates the optical delay profile in wavelength units introduced by a dual plate made from quartz and being 255 microns thick, as a function of the wavelength. It can be noted that a delay of 2.5 λ₁ is obtained for a wavelength λ₁ equal to 900 nm and that a delay of 2_{λ2} is obtained for a wavelength λ₂ equal to approximately 1110 nm. In this case, the integers N1 and N2 are both equal to 2. It follows that the polarization P_{λ1} of the first spectral component of wavelength λ₁ undergoes a rotation of 90 degrees during the crossing of the dual plate 41 and that the polarization P_{λ2} of the second spectral component of wavelength λ₂ remains unchanged when crossing the dual plate 41.

The first spectral component and the second spectral component cross the dual plate 41 and emerge in the direction of the nonlinear crystal 3 with polarizations perpendicular to each other until penetrating the nonlinear crystal 3. The nonlinear crystal 3 generates pulses at a wavelength λ_{MIR} in the mid-infrared by a process of difference frequency generation between the first spectral component of wavelength λ₁ and the second spectral component of wavelength λ₂ One of the first spectral component of wavelength λ₁ and the second spectral component of wavelength λ₂ constitutes the pump beam of the difference frequency generation process, the other constitutes the signal beam (as named in the terminology of nonlinear optical phenomena).

As will be described subsequently, the geometric adjustment of the dual plate 41 makes it possible to increase the efficiency of the process of generating at least one pulse at the wavelength λ_{MIR}.

In a first embodiment, a retardation plate 42 is located on the alignment optical axis of the generation device 1 downstream of the nonlinear crystal 3, i.e. that the nonlinear crystal 3 is located between the optical source 2 and the retardation plate 42. In this first embodiment, the generation device 1 further comprises a first optical parametric amplifier 5 downstream of the delay plate 42, as illustrated in FIG. 5.

In this first embodiment, the first spectral component and the second spectral component contained in the source pulse emitted by the optical source 2 propagate towards the nonlinear crystal 3. The nonlinear crystal 3 generates, for each source pulse emitted by the optical source, a pulse of wavelength λ_{MIR} in the mid-infrared by a process of difference frequency generation between the first spectral component of wavelength λ₁ and the second spectral component of wavelength λ₂

In this first embodiment, the nonlinear crystal 3 is a birefringent crystal, arranged so that its two own axes, hereinafter called slow axis 31 and fast axis 32, are transverse to the alignment optical axis D of the device.

The retardation plate 42 receives each pulse at the wavelength λ_{MIR} coming from the nonlinear crystal and transmits it towards the first optical parametric amplifier 5.

The retardation plate 42 also receives a pump radiation emerging from the nonlinear crystal 3 and having the first wavelength λ₁ or the second wavelength λ₂ from an emerging component emanating either from the first spectral component of wavelength λ₁ or from the second spectral component of wavelength λ₂ The retardation plate 42 transmits this pump radiation towards the first optical parametric amplifier 5.

Due to the different refraction index for the first wavelength λ₁, the second wavelength λ₂, and the wavelength λ_{MIR} in the nonlinear crystal 3, it is possible that the latter introduces a group velocity difference between the pulse at the wavelength λ_{MIR} originating from the nonlinear crystal 3 and the pump radiation emerging from that one. By group velocity, we mean the speed with which the envelope of a pulse spreads in a medium. This group velocity difference is due to the optical delay introduced by the nonlinear crystal 3 between the pulse at the wavelength λ_{MIR} coming from the nonlinear crystal 3 and the pump radiation emerging therefrom.

As will be described in the following, in this first embodiment, the pulse at the wavelength λ_{MIR} coming from the nonlinear crystal 3 and the pump radiation emerging therefrom have polarizations perpendicular to the alignment optical axis of the generation device 1, one being an ordinary polarization with respect to the nonlinear crystal 3, the other being an extraordinary polarization with respect to it.

Advantageously, the retardation plate 42 is a birefringent plate of which the material, the thickness and the orientation of cut are chosen for compensating the group velocity difference previously cited.

Otherwise said, the retardation plate 42 introduces an optical delay allowing to synchronize in the first optical parametric amplifier the pulse at the wavelength λ_{MIR} in mid-infrared with the pump radiation at the first wavelength λ₁ or at the second wavelength λ₂. The optical delay introduced by the retardation plate 42 between the pulse at the wavelength λ_{MIR} coming from of the nonlinear crystal 3 and the pump radiation emerging from it is equal to the opposite of the optical delay introduced by the nonlinear crystal 3 between the pulse at the wavelength λ_{MIR} coming from the nonlinear crystal 3 and the pump radiation emerging from this one. The retardation plate 42 can, for example, be a magnesium fluoride (MgF₂) plate or a langasite (LGS) plate, the cut of which does not allow for a phase match.

The pump radiation having the first wavelength λ₁ or having the second wavelength λ₂ is used as a pump beam of the first optical parametric amplifier (in the terminology of optical parametric amplifiers), whereas the pulse at the wavelength λ_{MIR} is used as a signal beam. So, at the output of the optical parametric amplifier, the pump beam is depleted and the beam signal, that is to say the pulse at the wavelength λ_{MIR}, is amplified.

Advantageously, the retardation plate 42 has a window with wide spectral transparency allowing for a good transmission of the pulse at the wavelength λ_{MIR} and of the pump radiation emerging from the nonlinear crystal 3 which will interact in the first optical parametric amplifier 5.

The retardation plate 42 can be formed from the same material as that of the first optical parametric amplifier 5, but under the condition that in the case of the retardation plate 42, the material be cut in such manner that no phase match be possible between the pulse at the wavelength λ_{MIR} and a pump radiation emerging from the nonlinear crystal 3 in the retardation plate 42.

A second embodiment can be obtained by combining the first embodiment with the use of a dual plate 41 as previously described.

In the embodiments previously described, the generation device 1 is aligned along the alignment optical axis D due to the collinearity of different pulses and radiation issued, either in the nonlinear crystal 3 or in the retardation plate 42 or in the dual plate 41. By collinearity, we mean a spatial superposition of the different beams.

### Method

We will now describe how, in the example previously described where a dual plate 41 is placed transversely on the alignment optical axis of the generation device 1 between the optical source 2 and the nonlinear crystal 3, the dual plate 41 is arranged geometrically to make it possible to increase the efficiency of the generation process of the at least one pulse at the wavelength λ_{MIR} by the nonlinear crystal 3. This arrangement is illustrated in FIG. 6.

A user positions the optical source 2 on an optical table or any other support. The user then positions the nonlinear crystal 3 so that its both own axes, the slow axis 31 and the fast axis 32, are perpendicular to the alignment optical axis D of the device. The user turns on the optical source 2, which emits then a succession of laser source pulses between 0.4 and 2.5 microns, preferably between 0.7 and 2.5 microns. The source pulse beam is polarized, for example linearly, with the polarization Pₛ.

It is considered that the difference frequency process takes place between the first spectral component of wavelength λ₁ and the second spectral component of wavelength λ₂ in the nonlinear crystal 3. In other words, the difference frequency will be generated by interaction between a first light portion polarized according to an ordinary polarization with respect to the nonlinear crystal 3, and a second light portion polarized according to an extraordinary polarization towards the nonlinear crystal 3.

In a configuration without the dual plate 41, it is conventional to orient the linear polarization of the source pulse beam so that it forms an angle of 45 degrees with the own axes of the nonlinear crystal 3. In this case, all spectral components of the spectrum of each source pulse are distributed equitably between the ordinary polarization on the one hand and the extraordinary polarization on the other hand.

In other words, for each source pulse, half of the photons entering the crystal are polarized with an ordinary polarization and the other half of the photons entering in the nonlinear crystal 3 is polarized with an extraordinary polarization. These two halves interact with each other to generate the difference frequency process. Therefore, without dual plate 41, the energy of the generated pulse is impacted by the effective use of only half of the incident energy for the difference frequency generation process.

It is considered that the dual plate 41 is a birefringent plate. The user positions the dual plate 41 between the optical source 2 and the nonlinear crystal 3. The user sets either the optical source 2 or the angular orientation of the dual plate 41 around of the alignment optical axis of the generation device 1, so that the direction of the linear polarization Pₛ of the source pulse beam forms an angle of 45 degrees with the own axes 43 and 44 of the dual plate 41.

In this way, the polarization P_{λ2} of the second spectral component of wavelength λ₂ is not impacted when it passes through the dual plate 41, as explained above. The polarization P_{λ1} of the first spectral component at the wavelength λ₁, which is oriented at 45 degrees from one of the own axes of the dual plate 41, undergoes itself a rotation of 90 degrees with respect to its original position due to the optical delay R1 (that is to say the half-wave plate effect of the dual plate on the first spectral component). Thus, the first spectral component of wavelength λ₁ and the second spectral component of wavelength λ₂ have polarizations orthogonal to each other.

In this way, a portion P1 of the spectrum containing the first spectral component of wavelength λ₁ undergoes a rotation of the polarization of an angle of 90°, while the complementary portion P2 of the spectrum containing the second spectral component of wavelength λ₂ does not undergo a change in polarization.

In other words, the dual plate 41 has the effect of separating, in polarization, the first spectral component of wavelength λ₁ and the second spectral component of wavelength λ₂.

FIG. 7 illustrates the different spectral densities Sₛ, Sₑ, and Sₒ corresponding respectively to the source pulse in the near infrared emitted by the source 2, to the part of the spectral density Sₛ polarized according to a extraordinary polarization with respect to the nonlinear crystal 3, and to the part of the spectral density Sₛ polarized according to an ordinary polarization with respect to the nonlinear crystal 3.

The user then adjusts the orientation of the nonlinear crystal 3 in its plane in order to optimize an average power of the pulses at the wavelength λ_{MIR} measured downstream of a plate, for example made of Germanium, filtering the radiation corresponding to the source pulses and positioned downstream of the nonlinear crystal 3. This is the phase matching adjustment.

The phase matching adjustment is selective for a couple of wavelengths (λ₁, 2). The first spectral component at the wavelength λ₁ and the second spectral component at the wavelength λ₂ are the components which will interact in the nonlinear crystal 3 in the difference frequency generation process.

In the case where the nonlinear crystal 3 is a birefringent crystal, the user must orient the nonlinear crystal 3 so that the own axes 31 and 32 thereof are aligned with the directions of the polarizations P_{λ1} and P_{λ2}. As shown in FIG. 6, the optimal configuration can be obtained when the P_{MIR} polarization of the pulse at the wavelength λ_{MIR} generated in the nonlinear crystal 3 is aligned with the own axis 31, corresponding to the polarization direction P_{λ2} thereof. A second optimal configuration could be obtained when the P_{MIR} polarization of the pulse at the wavelength λ_{MIR} generated in the nonlinear crystal 3 is aligned with the other own axis 32, corresponding to the polarization direction P_{λ}thereof.

Using a fiber amplifier doped with Ytterbium as optical source 2 as illustrated further up, a dual plate 41 made of quartz with a thickness of 255 microns and an LGS crystal with a thickness of 1 mm, and an incident average power on the LGS crystal of approximately 20 W, an average power in the mid-infrared MIR, with a central wavelength λ_{MIR} of 7.7 microns, of 22.5 mW is measured. Taking into account reflections at interfaces of the nonlinear crystal 3 and of the plate made of Germanium, the estimated average power of the pulses at the wavelength λ_{MIR} just at the output of the nonlinear crystal 3 is approximately 32 mW. The efficiency of the process of intra-pulse difference frequency generation obtained, as defined by the ratio of the average power in the mid-infrared and the average power incident on the nonlinear crystal 3, is therefore approximately 0.25%.

For comparison, without the dual plate 41, with the same optical source 2 and the same nonlinear crystal 3, and the linear polarization of the source pulse beam forming an angle of 45° with the own axes 31 and 32 of the nonlinear crystal 3, the MIR power measured after the Germanium plate is 9 mW and approximately 13.6 mW just at the output of the nonlinear crystal 3, taking into account the losses previously mentioned. The efficiency of the intra-pulse difference frequency generation process is in this case 0.09%. Thus, the use of the dual plate 41 makes it possible to increase the efficiency of a device for generating an intra-pulse difference frequency of the state of the art by a factor of at least 2.5.

Table 1 shows the results obtained with the previous device 1 and different thickness values of the LGS crystal:

TABLE 1

| Thickness of the LGS | Average power MIR | Average power MIR |
|---|---|---|
| crystal (mm) | without dual plate (mW) | with dual plate (mW) |
| 0.25 | 1.6 | 3.5 |
| 0.5 | 4 | 7 |
| 2 | 20 | 45 |
| 3 | 30 | 70 |

Table 2 shows the efficiency obtained with the preceding device 1 for a thicknesses of 1 mm and 3 mm:

TABLE 2

| Thickness of the LGS | Efficiency iDFG | Efficiency iDFG |
|---|---|---|
| crystal (mm) | without dual plate (%) | with dual plate(%) |
| 1 | 0.09 | 0.25 |
| 3 | 0.2 | 0.5 |

FIG. 8 shows the spectrum of the pulses at the wavelength λ_{MIR} obtained with a Fourier transform spectrometer obtained with an LGS crystal having a thickness of 1 mm. The wavelength λ_{MIR} of maximum power Is 7.7 microns and the passing band at −20 dB extends between 6.5 microns and 11.2 microns or over a band width of approximately 4.7 microns, corresponding to pulses at the wavelength λ_{MIR} with a duration of approximately 56 fs (approximately two optical cycles).

It will now be described how, in the first embodiment of the device for generation of pulses in the mid-infrared, the retardation plate 42 is arranged geometrically to allow for amplifying the at least one pulse at the wavelength λ_{MIR} generated by the nonlinear crystal 3.

As noted previously, it is considered that the process of difference frequency takes place between the first spectral component of wavelength λ₁ and the second spectral component of wavelength λ₂ in the nonlinear crystal 3 The difference frequency is generated by interaction between a first light portion polarized according to an ordinary polarization with respect to the nonlinear crystal 3, and a second light portion polarized according to an extraordinary polarization with respect to the nonlinear crystal 3.

The user positions the optical source 2 on an optical table or any other support. The user then positions the nonlinear crystal 3 in such a manner that its two own axes, the slow axis 31 and the fast axis 32, are perpendicular to the alignment optical axis D of the device. The user turns on the optical source 2, which then emits a succession of source pulses in the near infrared. The source pulse beam is polarized, for example linearly, with polarization Pₛ.

The user adjusts either the optical source 2 or the angular orientation around the alignment optical axis D of the generation device 1 of the nonlinear crystal 3, so that the direction of the linear polarization of the source pulse beam forms an angle of 45 degrees with the own axes of the nonlinear crystal 3. In this case, all spectral components of the spectrum of each source pulse are distributed equitably between the ordinary polarization on the one hand and the extraordinary polarization on the other hand.

Thus, the first spectral component of wavelength λ₁ has two portions P₁₁ and P₁₂ respectively polarized according to an ordinary polarization of the nonlinear crystal 3 and according to an extraordinary polarization of the nonlinear crystal 3. Likewise, the second spectral component of wavelength λ₂ has two portions P₂₁ and P₂₂ respectively polarized according to an ordinary polarization of the nonlinear crystal 3 and according to an extraordinary polarization of the nonlinear crystal 3.

In this way, depending on the orientation of the nonlinear crystal, either the portions P₁₁ (polarized according to an ordinary polarization) and P₂₂ (polarized according to an extraordinary polarization) interact in the difference frequency generation process taking place in the nonlinear crystal 3, or the portions P₁₂ (polarized according to an extraordinary polarization) and P₂₁ (polarized according to an ordinary polarization) interact in this process.

A pulse at the wavelength λ_{MIR} and two emerging rays at the wavelengths λ₁ and λ₂ and orthogonal polarizations between them get out of the nonlinear crystal 3. The pulse at the wavelength λ_{MIR} has a polarization P_{MIR} orthogonal to the polarization either of the emerging radiation at wavelength λ₁ or of the emerging radiation at the wavelength λ₂. In order to simplify the statement which will follow, it is considered that the polarization P_{MIR} is orthogonal to the polarization P_{λ1} of the radiation of wavelength λ₁. The radiation of wavelength λ₁ is thus the pump radiation emerging from the nonlinear crystal 3 previously mentioned. The principle of amplifying the at least one pulse at the wavelength λ_{MIR} generated by the nonlinear crystal 3 is shown in FIG. 9.

As can be observed in FIG. 9, the nonlinear crystal 3 can introduce a group difference between the pulse at the wavelength λ_{MIR} and the pump radiation emerging from the nonlinear crystal 3 (here the radiation of wavelength λ₁), which are desynchronized after emerging from the nonlinear crystal 3.

The user positions the first optical parametric amplifier 5 downstream of the nonlinear crystal 3 on the alignment optical axis D of the generation device 1. The pulse at the wavelength λ_{MIR} constitutes the “signal” beam>> of the optical parametric amplifier and will be amplified by a nonlinear interaction with the pump radiation emerging from the nonlinear crystal 3 in the first optical parametric amplifier 5.

Then, the user positions the retardation plate 42 so that its plane is perpendicular to the alignment optical axis of the device D.

In the case where the retardation plate 42 is a birefringent plate of which the material, the thickness and the orientation of cut are chosen to compensate for the group velocity difference introduced by the nonlinear crystal 3, the user adjusts the angular orientation of the retardation plate 42 in its plane in order to optimize the power at the output of the first optical parametric amplifier.

When the power at the output of the first optical parametric amplifier 5 is optimal due to adjustment of the orientation of the retardation plate 42, the pulse at the wavelength λ_{MIR} and the pump radiation emerging from the nonlinear crystal 3 are synchronized at the output of the retardation plate 42 as shown in FIG. 9. The pulse at the wavelength λ_{MIR} and the pump radiation emerging from the nonlinear crystal 3 interact in an optimal way in the first optical parametric amplifier 5, so that an amplified output pulse at the wavelength λ_{MIR} gets out from the latter. The first optical parametric amplifier thus allows to increase the power by a factor >1, typically by a factor between 1.5 and 10, of the pulse at the wavelength λ_{MIR} initially generated by the nonlinear crystal 3.

The efficiency of generating a pulse at the wavelength λ_{MIR} generated by the nonlinear crystal 3 can be increased in combining the uses of the embodiments of the generation device 1 with the dual plate 41 and with the retardation plate 42. The user first carries out the adjustment previously described with the dual plate 41, then the adjustment previously described with the retardation plate 42.

Thus, the invention advantageously makes it possible to increase the efficiency of a device for generating pulses in the mid-infrared via an optical parametric amplification process by using at least one plate introducing an optical delay. Also, the configuration <<All aligned>> of the device according to the invention facilitates its use and alignment.

### Variants

The present invention is in no way limited to the embodiments described and represented, but the person skilled in the art will be able to bring in all variants compliant with the invention.

According to the present disclosure, the dual plate 41 can have a variable thickness: it can consist of two right angle prisms 411 and 412 in contact and formed in the same birefringent material and constituting together a resulting birefringent plate. The dual plate 41 corresponds to this resulting birefringent plate. By translating one or the other of the prisms by one length s perpendicularly to the alignment optical axis D of the generation device 1 and perpendicularly to the edge of the prisms, it is possible to vary the thickness e of the dual plate 41 and to modify the order of the plate (integers N1 and N2), as illustrated in FIG. 10. The profile of an optical delay introduced by the dual plate depending on the wavelength is then modified. Thus, the first spectral component of wavelength λ₁ and the second spectral component λ₂ for which the optical delay D1 is equal to (N₁+1/2)×λ₁ and the optical delay D2 is equal to N₂x λ₂, can be adjusted. The generation device is therefore tunable and the wavelength λ_{MIR} can be adjusted.

Furthermore, by varying the thickness of the dual plate 41, the spectral width of the pulse at the wavelength λ_{MIR} can also be adjusted. Sₒ, the more the thickness of the dual plate 41 is big, the more the dual plate is chromatic. That is translated by an increase in the slope of the curve representing the optical delay introduced by the dual plate 41 as a function of the wavelength, illustrated for example in FIG. 4. In other words, the spectral components contained in the source pulse participating in the process of difference frequency generation are reduced. Consequently, the spectral width of the pulse at the wavelength λ_{MIR} is modified.

Moreover, the fact that the dual plate 41 has a variable thickness allows you to vary, by adjusting the thickness, the couple of wavelengths (λ₁, λ₂) for which the dual plate 41 respectively introduces the optical delay D1 and the optical delay D2. This makes it possible to modify and adjust the generated wavelength λ_{MIR}, by possibly readjusting the orientation of the nonlinear crystal 3 to adjust the phase match.

In a second variant, in the case where the pump radiation emerging from the nonlinear crystal 3 corresponds to the pump beam of the process of difference frequency generation (i.e. one of the first spectral component of wavelength λ₁ and the second spectral component of wavelength λ₂), several optical parametric amplifiers can be cascaded downstream of the first optical parametric amplifier 5 in order to successively amplify the pulse at the wavelength λ_{MIR} until exhausting the photons of the pump radiation emerging from the nonlinear crystal 3. The conversion efficiency is thus improved.

More precisely, in this other variant, we consider that the polarization P_{MIR} is orthogonal to the polarization P_{λ1} of the radiation of wavelength λ₁. The radiation of wavelength Mi is thus the pump radiation emerging from the nonlinear crystal 3. The process of difference frequency generation that takes place in the nonlinear crystal 3 depletes the radiation at the wavelength λ₁, amplifies the radiation at the wavelength λ₂, and generates the radiation at the wavelength λ_{MIR}. At the output of the nonlinear crystal 3, the radiation at the wavelength M and the radiation at the wavelength λ_{MIR} are not synchronized due to the group velocity difference introduced by the nonlinear crystal 3. As explained further up, the retardation plate 42 makes it possible to resynchronize the radiation at the wavelength λ₁ and the radiation at the wavelength λ_{MIR}

The pulse at the wavelength λ_{MIR} constitutes a “signal” beam of the first optical parametric amplifier 5 and will be amplified by a factor K₅ by nonlinear interaction with the pump radiation emerging from the nonlinear crystal 3 in the first optical parametric amplifier 5, whereas the pump radiation emerges from the nonlinear crystal 3, that is to say, the radiation at the wavelength λ₁ is depleted again, as shown in FIG. 11.

This process of amplifying the radiation at the wavelength λ_{MIR} and depletion of radiation at the wavelength λ₁ can be repeated by adding in cascade several optical parametric amplifiers, until the power of the radiation at the wavelength λ₁ becomes zero. Upstream of each additional optical parametric amplifier, a resynchronization of radiation at the wavelength λ₁ and of radiation at the wavelength λ_{MIR} is carried out by using a complementary retardation plate such as the retardation plate 42. Thus, the cascading of optical parametric amplifiers after the first optical parametric amplifier makes it possible to increase the efficiency of the radiation generation process at the wavelength λ_{MIR}

A third variant corresponds to the case where the pump radiation emerging from the nonlinear crystal 3 corresponds to the signal beam of the process of difference frequency generation, that is to say, radiation at wavelength λ₂ The principle is identical to the second variant previously described. FIG. 12 illustrates this variant. At the output of the nonlinear crystal 3, the radiation at the wavelength λ₂ and the radiation at the wavelength λ_{MIR} are not synchronized due to the fact of the group velocity difference introduced by the nonlinear crystal 3. As explained above, the retardation plate 42 makes it possible to resynchronize the radiation at the wavelength λ₂ and the radiation at the wavelength λ_{MIR}

The pulse at the wavelength λ_{MIR} constitutes the “signal” beam of first optical parametric amplifier 5 and will be amplified by a factor K₅ by nonlinear interaction with the pump radiation emerging from the nonlinear crystal 3 in the first optical parametric amplifier 5, whereas the pump radiation emerging from the nonlinear crystal 3, that is to say, the radiation at the wavelength λ₂ is depleted again, as shown in FIG. 11.

This process of amplifying radiation at the wavelength λ_{MIR} and depletion of radiation at the wavelength λ₂ can be repeated by adding in cascade several optical parametric amplifiers until the power of radiation at the wavelength λ₂ becomes zero. Upstream of each additional optical parametric amplifier a resynchronization of the radiation at the wavelength λ₂ and of the radiation at the wavelength λ_{MIR} is carried out by the use of a complementary retardation plate such as the retardation plate 42. Thus, just as in the second variant, the cascading of optical parametric amplifiers after the first optical parametric amplifier 5 makes it possible to increase the efficiency of the process of generating radiation at the wavelength λ_{MIR}.

A fourth variant, illustrated in FIG. 13, uses a cascade of optical parametric amplifiers aligned downstream of the first optical parametric amplifier 5. Each nonlinear interaction taking place in an optical parametric amplifier Ai, i being an integer greater than or equal to 1, amplifies the radiation at the wavelength λ_{MIR} and generates so-called “idler” radiation at the wavelength λ_{idler_i} smaller than the wavelength λ_{MIR}.

The variant consists, downstream of the optical parametric amplifier 5, in resynchronizing the radiation at the wavelength λ_{MIR} with the radiation at the wavelength λ_{idler_i} with a complementary retardation plate 421 such as the retardation plate 42, where i is an integer greater than or equal to 1. The radiation at the wavelength λ_{idler_i} constitutes the pump radiation of the optical parametric amplifier Ai+1 and will interact with the radiation at the wavelength λ_{MIR} thereof, amplifying the radiation at the wavelength λ_{MIR} by a factor Kai and generating an idler radiation at the wavelength λ_{idler_i}+1 lower than the wavelength λ_{MIR}. The “idler” radiation at the wavelength λ_{idler_i}+1 serves as pump radiation for the optical parametric amplifier Ai+2. Thus, this cascade of optical parametric amplifiers also makes it possible to increase the efficiency of the process of generating radiation at the wavelength λ_{MIR}.

In a fifth variant, in the case of using the retardation plate 42, it is possible to focus the pulse at the wavelength λ_{MIR} and the pump radiation emerging from the nonlinear crystal 3 in the first optical parametric amplifier 5, for example by using a focusing element such as a lens positioned between the retarding plate 42 and the first optical parametric amplifier 5. The light intensity is then increased in the first optical parametric amplifier 5 as well as, consequently, the gain of interaction between the pulse at the wavelength λ_{MIR} and the emerging pump radiation. The pulse at the wavelength λ_{MIR} emerges from the first optical amplifier 5 with an increased power.

In this variant, the focusing element can introduce an additional group velocity difference between the pulse at the wavelength λ_{MIR} and the emerging pump radiation. The thickness or the material of the retardation plate 42 can then be adjusted for compensating this additional group difference in order to optimise the synchronization of the pulse at the wavelength λ_{MIR} and of the pump radiation emerging from the first parametric optical amplifier 5.

In a sixth variant, the first spectral component of wavelength λ₁ and the second spectral component of wavelength λ₂ are contained in two source pulses emitted by the optical source 2 but being distinct. Therefore, this variant is configured for implementing a process of inter-pulses difference frequency. For example, the optical source 2 can be an optical parametric amplifier generating two emerging pulses at wavelengths λ₁ and λ₂ respectively. The two emerging pulses are arranged to propagate collinearly, to have an identical polarization and for being temporally superimposed.

1. Device for the generation of at least one pulse in mid-infrared, comprising:
an optical source configured to emit at least one source pulse, the at least one source pulse having a first spectral component of wavelength λ₁ and a second spectral component of wavelength λ₂ located in a spectral range lower than mid-infrared,
a nonlinear crystal configured to generate said at least one pulse at a wavelength λ_{MIR} in the mid-infrared from the at least one source pulse by a process of difference frequency generation between the first spectral component of wavelength λ₁ and the second spectral component of wavelength λ₂,
a first optical parametric amplifier,
wherein:
the generation device comprises at least a retardation plate presenting an optical delay configured for two useful wavelengths, the two useful wavelengths being the wavelength λ_{MIR} in the mid-infrared and one among the first wavelength λ₁ and the second wavelength λ₂,
the generation device is a device aligned along an alignment optical axis,
the retardation plate is placed between the nonlinear crystal and the first optical parametric amplifier,
the retardation plate is configured to receive said at least one pulse of wavelength λ_{MIR} in the mid-infrared coming from the nonlinear crystal and to transmit it towards the first optical parametric amplifier,
the retardation plate is configured to receive a pump radiation emerging from the nonlinear crystal at the first wavelength λ₁ or at the second wavelength λ₂, and to transmit the pump radiation in the direction of the first optical parametric amplifier,
the optical delay of the retardation plate is suitable for synchronizing in the first optical parametric amplifier said at least one pulse at the wavelength λ_{MIR} in the mid-infrared with said pump radiation at the first wavelength λ₁ or at the second wavelength λ₂.

2. The generation device according to claim 1, wherein the retardation plate is a birefringent plate.

3. The generation device according to claim 2, wherein the material of the birefringent retardation plate and its cut are chosen to introduce a group velocity difference between said at least one pulse at the wavelength λ_{MIR} and said pump radiation at the first wavelength Mu or at the second wavelength λ₂, said group velocity difference being equal to the opposite of a group velocity difference, at the output of the nonlinear crystal, between said pump radiation and said at least one pulse at the wavelength λ_{MIR}.

4. The generation device according to claim 1, further comprising one or more additional optical parametric amplifiers positioned in cascade and downstream from the first optical parametric amplifier and including another retardation plate upstream from each additional optical parametric amplifier.

5. The generation device according to claim 1, further including a dual plate and wherein:
the dual plate has an optical delay configured for two useful wavelengths, the two useful wavelengths being the first wavelength Au and the second wavelength λ₂,
the dual plate is placed between the optical source and the nonlinear crystal,
the dual plate is configured for receiving said at least one source pulse and for transmitting it towards the nonlinear crystal,
the optical delay of the dual plate configured for the first wavelength λ₁ is equal to (N₁+1/2)×λ₁ and the optical delay of the dual plate configured for the second wavelength λ₂ is equal to N₂x λ₂, with N₁ and N₂ being two positive integers.

6. The generation device according to claim 5, wherein the dual plate has a fixed thickness.

7. The generation device according to the claim 5, wherein the dual plate consists of a pair of straight prisms suitable for moving in translation one with respect to the other, so that the thickness of the dual plate is variable.

8. The generation device according to claim 5, wherein the dual plate is a birefringent plate.

9. The generation device according to claim 1, wherein the first spectral component of wavelength λ₁ and the second spectral component of wavelength λ₂ are spatially superimposed.

10. The generation device according to claim 1, wherein the first spectral component of wavelength A and the second spectral component of wavelength λ₂ are spatially separated and spectrally disjoint.

11. Process of generating at least one pulse in the mid-infrared λ_{MIR} implemented by a generation device according to claim 1, comprising the following steps:
emission by an optical source of at least one source pulse, the at least one source pulse presenting a first spectral component of wavelength λ1 and a second spectral component of wavelength λ2 located in the near infrared,
reception of the at least one source pulse by a nonlinear crystal,
generation by said nonlinear crystal of said at least one pulse at a wavelength λ_{MIR} from the at least one source pulse by a process of difference frequency generation between the first spectral component of wavelength λ₁ and the second spectral component of wavelength λ2,
rotation of the retardation plate in its plane, and optionally, rotations of the retardation plate in directions perpendicular to the alignment optical axis D of the generation device.

12. The generation device according to claim 2, further comprising one or more additional optical parametric amplifiers positioned in cascade and downstream from the first optical parametric amplifier and including another retardation plate upstream from each additional optical parametric amplifier.

13. The generation device according to claim 3, further comprising one or more additional optical parametric amplifiers positioned in cascade and downstream from the first optical parametric amplifier and including another retardation plate upstream from each additional optical parametric amplifier.

14. The generation device according to claim 6, wherein the dual plate is a birefringent plate.

15. The generation device according to claim 7, wherein the dual plate is a birefringent plate.

16. The generation device according to claim 2, wherein the first spectral component of wavelength λ1 and the second spectral component of wavelength λ2 are spatially superimposed.

17. The generation device according to claim 3, wherein the first spectral component of wavelength λ1 and the second spectral component of wavelength λ2 are spatially superimposed.

18. The generation device according to claim 5, wherein the first spectral component of wavelength λ1 and the second spectral component of wavelength λ2 are spatially superimposed.

19. The generation device according to claim 2, wherein the first spectral component of wavelength λ1 and the second spectral component of wavelength λ2 are spatially separated and spectrally disjoint.

20. The generation device according to claim 5, wherein the first spectral component of wavelength λ1 and the second spectral component of wavelength λ2 are spatially separated and spectrally disjoint.
